(19) United States
(12) Patent Application Publication
(10) Pub. No.: US 2007/0076095 A1
(43) Pub. Date: Apr. 5, 2007

(54) Video Monitoring System Incorporating Cellular Phone Technology

(76) Inventor: Olga D. Tomaszewski, Clinton Township, MI (US)

Correspondence Address: THE INVENTORS NETWORK, INC., 332 ACADEMY STREET, CARNEGIE, PA, 15106, US

(21) Appl. No.: 11/163,023

(22) Filed: Oct. 3, 2005

(51) Int. Cl. H04N 7/18

(52) U.S. Cl. 348/155

(57) ABSTRACT

A video monitoring system that incorporates mobile cellular telephone technology to provide images or live video in real time to a parent or business owner for safety, security and surveillance purposes includes a surveillance camera mounted in or adjacent the room or site to be monitored, a control unit for transmitting the images received from the camera to the cellular telephone, a recording device for recording the activity, a electric eye connected to the camera and the control unit for actuating the camera upon physical interruption of the electric beam through, for example, opening a door to the room, and a speaker electrically interconnected to the control unit and the electric eye for broadcasting instructions, guidance, and reminders for the individual after the individual has opened the door and entered the room.

### DESCRIPTION

The present invention pertains to mobile video monitoring systems, and more particularly pertains to a video monitoring system that incorporates mobile cellular telephone technology for transmitting live images in real time for security, safety and monitoring purposes.

### BACKGROUND OF THE INVENTION

Electric monitoring and surveillance systems and devices are quite common in contemporary societies. Surveillance systems and cameras can be found in locations that range from department stores, banks, shopping plazas, 24 hour convenience stores, airports, and sporting venues to schools, day care centers, amusement parks, subways, and shipping docks. Despite the ongoing concerns with the possible infringements on civil liberties and individual rights, surveillance systems and cameras are widely used in all sorts of venues and locations for public and private safety measures. More significantly, concerns over international terrorism have actually caused an expansion of surveillance techniques and systems.

On the more mundane level, hectic work schedules, children and teenagers often home alone for hours with no supervision or under the nominal supervision of a babysitter, one and most likely both parents or adult guardians working, families separated geographically, and elderly members living apart and by themselves or in assisted care facilities and nursing homes have dramatically increased the need to maintain awareness and contact between and among all the parties. Parents want to be kept apprised of their children's' activities and the conditions at home, at school and certainly while at day care facilities, family members want to be kept apprised of the conditions of their parents or elderly family members and relatives residing alone, in assisted and extended care and living facilities and nursing homes, and, given the concerns regarding liability and employee behavior, business owners want to monitor and be kept apprised of the activities occurring at their businesses in an unobtrusive but timely manner. The widespread popularization of cell phones allows individuals to maintain continuous contact, but cellular phones are banned in many locations such as schools and hospitals. And while cellular telephones now include digital camera technology, not everyone has the facility for using cellular telephones; this is especially true for young children and elderly individuals uncomfortable and awkward around digital, handheld wireless technologies.

In view of the above, various wireless systems and technologies have been conceived to transmit voice and video, albeit largely for personal and business purposes with less emphasis on the personal safety monitoring aspect.

For example, the Duran et al. patent (U.S. Pat. No. 4,893,326) discloses a video-telephone communications system for transmitting voice, video or graphics information between two or more workstations utilizing either local area networks or long distance transmission systems.

The Choi et al. patent (U.S. Pat. No. 5,204,893) discloses a method and apparatus for transmitting and receiving signals in a videophone and simultaneously transmitting and receiving video and voice signals by a single transmission line.

The Hata et al. patent (U.S. Pat. No. 5,351,076) discloses a terminal system that includes video telephone equipment cooperating with a computer system for simultaneously communicating dynamic and static images and sounds to remote locations.

The Hicks, III, patent (U.S. Pat. No. 5,760,824) discloses a modular multimedia telephone that includes a wireless video cameral and television module, as well as a method of operation.

The McDonald patent (U.S. Pat. No. 6,335,753 B1) discloses a wireless communication video telephone that is retained on a wall and includes remote control capabilities for transmitting both audio and video signals by satellite or by cellular communication channels.

The Yang patent (U.S. Pat. No. 6,459,906 B1) discloses a method of controlling the operation of a TV phone and includes a method for displaying a character message received from an integrally combined television and portable cellular phone in a scrolling manner on the viewing screen.

Nonetheless, despite the ingenuity of the above devices there remains a need for a video monitoring system that also provides real time live images and motion actuated audible instructions, guidance and reminders to anyone entering the room where the video monitoring system is located.

### SUMMARY OF THE INVENTION

The present invention comprehends a video monitoring system that incorporates cellular telephone technology for relaying live, real time images or video to the mobile cellular telephone thereby allowing the parent, homeowner, caregiver or business owner to monitor and be kept apprised of activities occurring in, for example, the home, day care center, extended or assisted living facility, or business.

The video monitoring system of the present invention includes one or more surveillance cameras mounted to a wall or ceiling or other surface by a platform or bracket, with the camera being pivotally mounted thereon for wide angle panning and viewing. The surveillance camera can be mounted in any room of the house, day care center, work site or business, and the camera will be able to transmit live images or video in real time to a cellular telephone in possession of the parent, guardian, caregiver, health care professional, or business owner. The surveillance camera is electrically interconnected to a control box or unit having wireless capabilities for transmitting, over suitable frequencies and channels, images in real time to the cellular telephone. A recording unit, such as a standard VCR unit, is electrically interconnected to the control unit for visually recording the activities occurring within the room, area, or site being monitored. The cassette tapes made from the recordings can be saved for documentation, evidence and legal purposes should any questionable instances occur that raise possible legal or criminal matters and issues.

In addition to simply having the surveillance camera turned on all the time and possibly recording no activities as the individual being monitored may often leave the room for long periods of time, the operation of the camera can be programmed to record only when the individual is in the room, site or area under surveillance. To accomplish this at least one electric eye is mounted in the direct line of sight with a door opening into the room, and the electric eye is electrically interconnected to the surveillance camera and the control unit so that opening of the door interrupts the electrical signal of the electric eye thereby actuating the surveillance camera. The actuation of the surveillance camera also simultaneously actuates the control unit and the recording unit for operation. Moreover, there may be situations where instructions, commands, guidance and reminders must be provided to the individual entering the room, such individual being a small child or an elderly person that must be instructed to turn off the lights, take a certain medication or receive specific orders. To communicate such commands, instructions, guidance and reminders, a speaker can be mounted to the wall and electrically interconnected to the control unit so that upon actuation by the control unit one of a series of preprogrammed responses can be emitted by the speaker.

It is an objective of the present invention to provide a video monitoring system incorporating cellular telephone technology for monitoring the activities in a home or business, and then transmitting video off-site to a mobile cellular telephone.

It is another objective of the present invention to provide a video monitoring system incorporating cellular telephone technology that transmits live video images to a mobile cellular telephone.

It is still another objective of the present invention to provide a video monitoring system incorporating cellular telephone technology that includes a motion activated sensor eye integrated with the video monitoring system for actuating audible instructions, commands, and warnings.

It is still yet another objective of the present invention to provide a video monitoring system incorporating cellular telephone technology wherein actuation of the sensor eye initiates the playing of pre-recorded instructions tailored to the particular individual that has initiated the playing of the pre-recorded instructions.

Still another objective of the present invention is to provide a video monitoring system incorporating cellular telephone technology that allows for continuous around-the-clock monitoring of the residence, business, room or area where the monitoring system is located.

Still yet another objective of the present invention is to provide a video monitoring system incorporating cellular telephone technology that allows parents, caregivers, and business owners to be continuously apprised of the activities occurring inside the dwelling in which the video monitoring system is located.

Yet another objective of the present invention is to provide a video monitoring system incorporating cellular telephone technology that allows aging parents to maintain their independence from their children while still allowing their activities to be periodically monitored for their own safety and the reassurance of their children.

Yet still another objective of the present invention is to provide a video monitoring system incorporating cellular telephone technology that allows parents, while at work, to monitor the activities of their housebound children.

A still further objective of the present invention is to provide a video monitoring system incorporating cellular telephone technology that allows an elderly individual to be unattended to function and live independent of family members and caregivers while being unobtrusively monitored for their own safety and well being.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the video monitoring system of the present invention illustrating the primary elements of the system that includes a surveillance camera, a video recording unit, and a wireless control unit for transmitting images to the cellular telephone;

FIG. 2 is an enlarged perspective view of the video monitoring system of the present invention first shown in FIG. 1 illustrating the surveillance camera mounted to a wall and interconnected to the recording unit and the wireless control unit;

FIG. 3 is a perspective view of the video monitoring system of the present invention illustrating the inclusion of an electric eye and a speaker interconnected with the surveillance camera, the video recording device and the control unit;

FIG. 4 is a top plan view of the video monitoring system of the present invention illustrating the actuation of the electric eye by the opening of a door;

FIG. 5 is an enlarged perspective view of the video monitoring system of the present invention illustrating the electric eye and the speaker first shown in FIG. 3 interconnected with the other elements of the system;

FIG. 6 is an electrical schematic of the video monitoring system of the present invention showing the electrical interconnections, both hard-wired and wireless, between the surveillance camera, the control unit/wireless router, the recording device and the cellular telephone;

FIG. 7 is an electrical schematic of the video monitoring system of the present invention showing the electrical interconnections, both hard-wired and wireless, between the surveillance camera, the control unit/wireless router, the recording device, the electric eye, the speaker and the cellular telephone; and

FIG. 8 is a flowchart of the video monitoring system of the present invention illustrating the steps undertaken by the system upon actuation of the system by the opening of a door interrupting the electrical signal of the electric eye.

### DETAILED DESCRIPTION OF THE PREFERRED EMBODIMENT

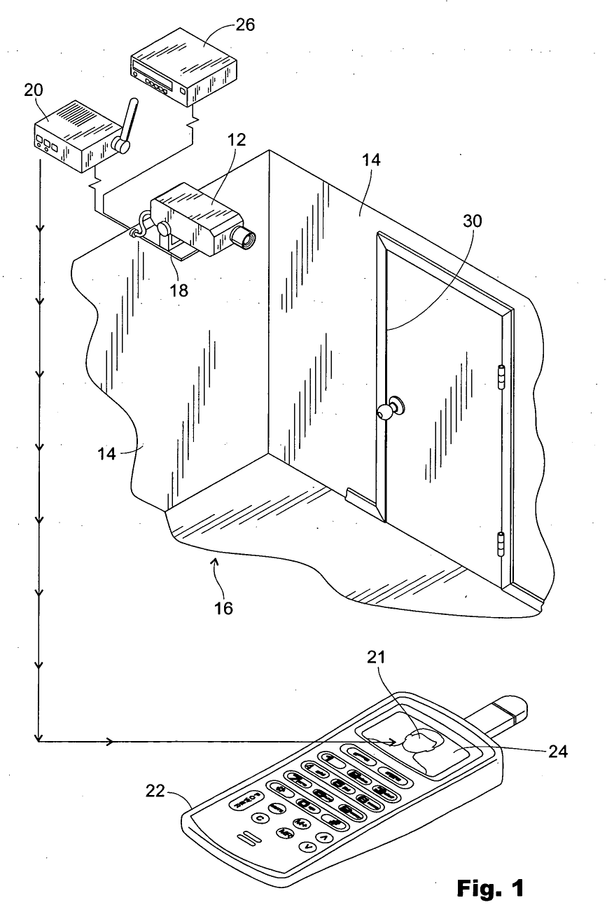

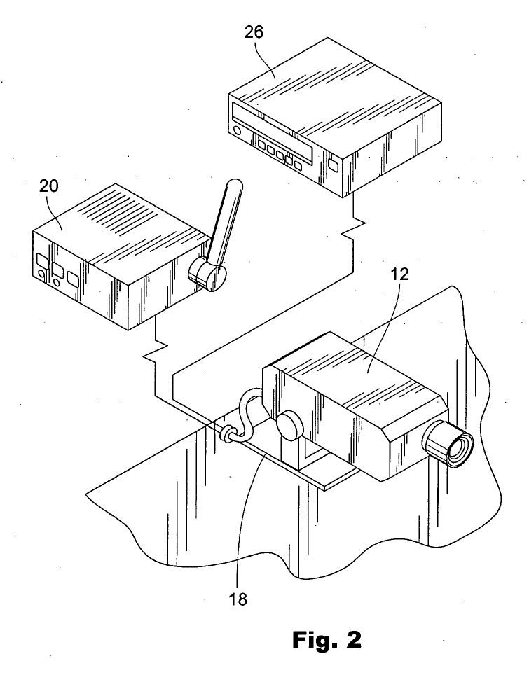

Illustrated in FIGS. 1-8 is a video monitoring system 10 that incorporates and utilizes mobile (and preferably handheld) cellular telephone technology for continuously monitoring and transmitting, in real time, live images and video to the cellular telephone thereby allowing a parent, guardian, medical personnel or business owner to monitor and be kept apprised of activities occurring in the home, business or other site or location. The video monitoring system 10 can also be disposed in the residence of an elderly individual to allow children, relatives, caregivers and health care professionals to monitor the safety of the elderly individual while granting him or her the dignity and freedom of independent living. In addition, the video monitoring system 10 of the present invention provides working parents with a measure of reassurance by monitoring the activities and occurrences of their housebound children while the parents are away at work. Furthermore, the video monitoring system 10 includes a speaker capability to provide instructions, guidance, and reminders to the individual or individuals being monitored; and such instructions and reminders can include such things as turning the lights out when leaving, turning the television off, checking the laundry, making a phone call, and taking medications.

Thus, illustrated in FIGS. 1-8 is the video monitoring system 10 that includes a video monitoring device such as a surveillance camera 12 of the type widely used in business, industry and such public buildings and venues as schools, banks and sporting events. The surveillance camera 12 is mounted to a wall 14 of a room 16 or site to be monitored by a platform or bracket 18. The camera 12 is mounted at a location or position that provides an optimal vantage for continuous monitoring of the desired room, site or area. The camera 12 can be pivotally mounted to the platform 18 for enhancing the optimal viewing and panning capacity of the camera 12 in the room 16 in which it is disposed. The pivotal mounting allows the camera 12 to be adjusted and pivoted vertically or horizontally, or, if a ball joint is used as a swivel, to pivot in both the vertical and horizontal directions and orientations.

As shown in FIGS. 1-8, a control unit 20 is electrically interconnected to the surveillance and monitoring camera 12 for controlling the basic operations of the camera 12. The control unit 20 will include such standard electrical circuitry components as a microprocessor, memory storage, a transmitter, and a receiver. The control unit 20 will also include an antenna for wireless communication and transmission capability, and such wireless transmission will include the conveyance or streaming of live images and video 21 to a source that for the present invention is preferably a mobile, handheld cellular telephone 22. The cellular telephone 22 will be of the type capable of receiving and decoding analog and/or digital transmissions, and recreating such transmissions into images and video 21 viewable on the viewing screen 24 of the cellular telephone 22. Thus, the transmission range of the video monitoring system 10 will be dependent upon, in part, the cellular telephone service or provider utilized by that particular individual, i.e., parent or business owner.

Electrically interconnected to both the surveillance camera 12 and the control unit 20 is a recording unit or device 26 that, in a preferred embodiment, can be a videocassette recorder. The recording device 26 operates simultaneously with both the camera 12 and the control unit 20 for continuously recording whatever events and occurrences transpire within the room 16, site or area being monitored. In addition to actually recording occurrences within the monitoring site or area, the recording device 26 also preserves a visual record of everything that has happened in the room or site being monitored for a given time period. This is especially critical if the surveillance camera 12 should record events that give rise to legal or criminal issues, such as a babysitter striking the child being watched or an employee stealing from the business.

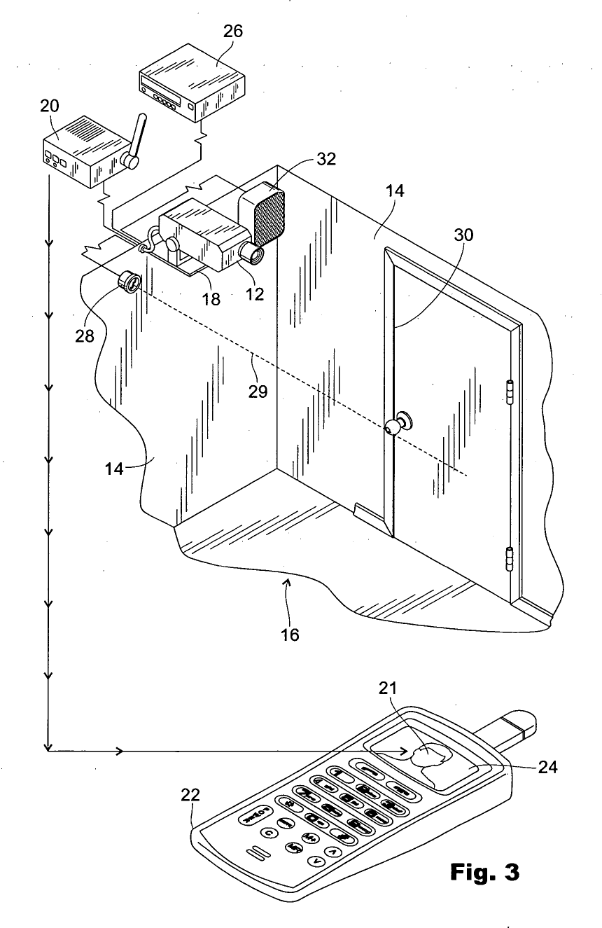

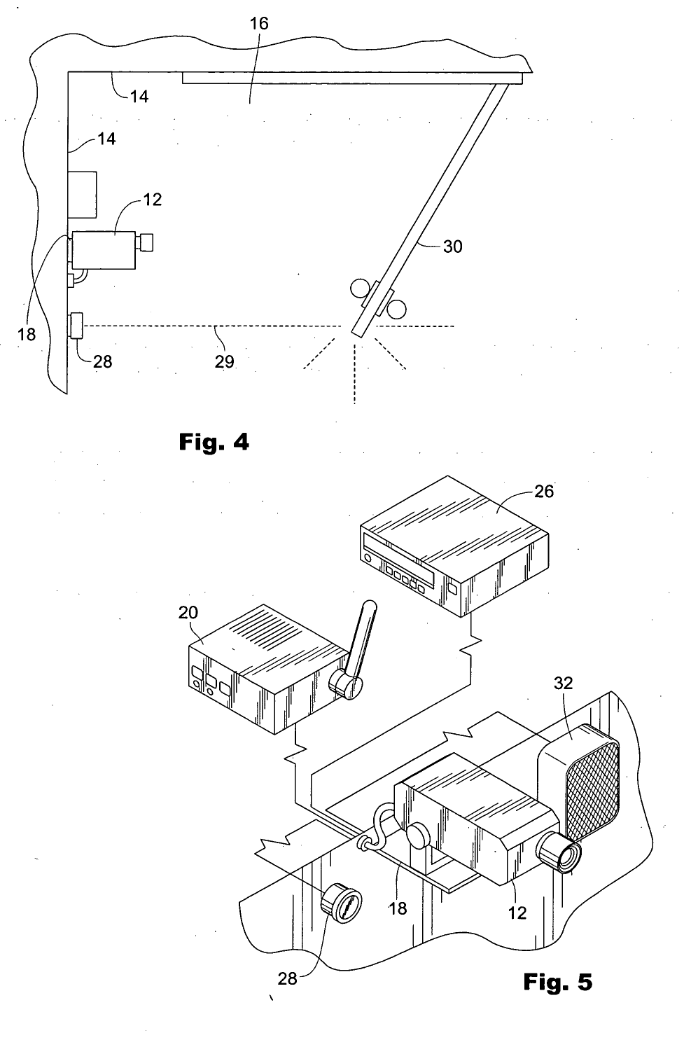

Illustrated in FIGS. 3-5 and 7 and 8 are several additional features of the video monitoring system 10 that augment the monitoring capabilities. An electric eye 28 can be used to more specifically control the activation and monitoring of the surveillance camera 12. The electric eye 26 is electrically interconnected to the surveillance camera 12 and the control unit 20. As shown in FIGS. 3 and 4, the electric eye 28 is actuated—motion activated—upon a door 30 opening and interrupting an electrical beam 29 produced by the electric eye 29, and the video monitoring system 10 utilizing the electric eye 28 can be set up and programmed in several different ways. In one set up or mode of operation, the video monitoring system 10 will be turned on and immediately disposed to surveillance mode, and when a physical motion such as opening the door 30 triggers the electric eye 28, a signal will be sent to the control unit 20 for actuating a speaker 32 mounted in the room 16 or site. A pre-recorded or pre-programmed message will then be broadcast from the speaker 32, such message being in the form of instructions, guidance, and reminders, for instance, turning out the lights, locking the door, and performing household chores or taking a medication. An alternative mode of operation is to have the video monitoring system 10 set in an inactive mode, and upon the motion of the door 30 triggering the electric eye 28, a signal is conveyed to the control unit 20 thereby actuating the control unit 20 and switching or turning on the recording device 26, the surveillance camera 12 and the speaker 32. This mode avoids the surveillance camera 12 recording nothing or no activity within in the room 16 or site being monitored. To avoid accidental or inadvertent triggering of the video monitoring system 10, the electric eye 28 can operate on a five or 10 second delay to avoid situations where someone opens and then closes the door 30 without entering the room 16.

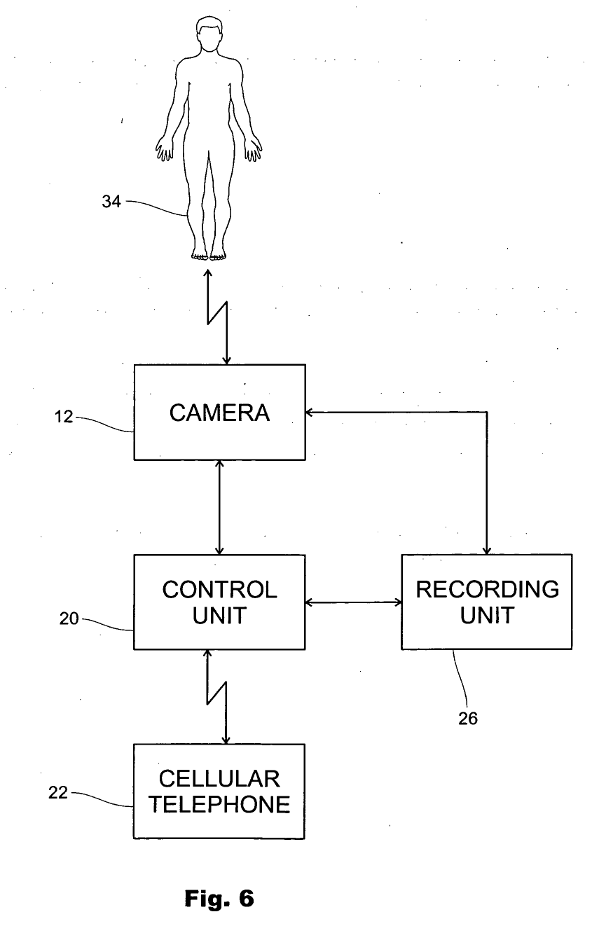

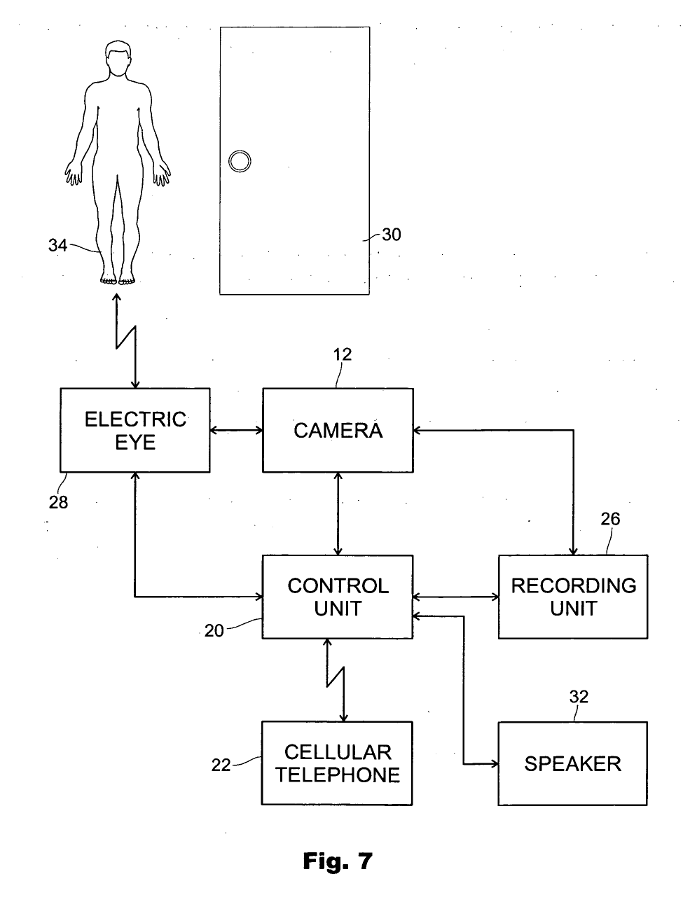

Illustrated in FIG. 6 is the embodiment of the invention that includes the surveillance camera 12 recording the activities of one or more individuals 34 that enters the room 16, site or area being monitored, and that is electrically interconnected to the control unit 20 and recording unit 26. The control unit 20 transmits live images and video to the cellular telephone 22 by any suitable wireless transmission protocol. FIG. 7 illustrates the inclusion of the electric eye 28 and the speaker 32. Opening the door 30 actuates the electric eye 28, and this in turn initiates the control unit 20 to transmit the appropriate signal from the control unit 20 to the recording unit 26 for activating the recording unit 26 to emit the pre-recorded message—or series of messages—in the form of instructions, guidance, and reminders to the individual 34 entering the room 16. To avoid repeating the message or messages each time the individual 34 enters and then leaves the room 16, the pre-recorded messages may be programmed for only a one-time play.

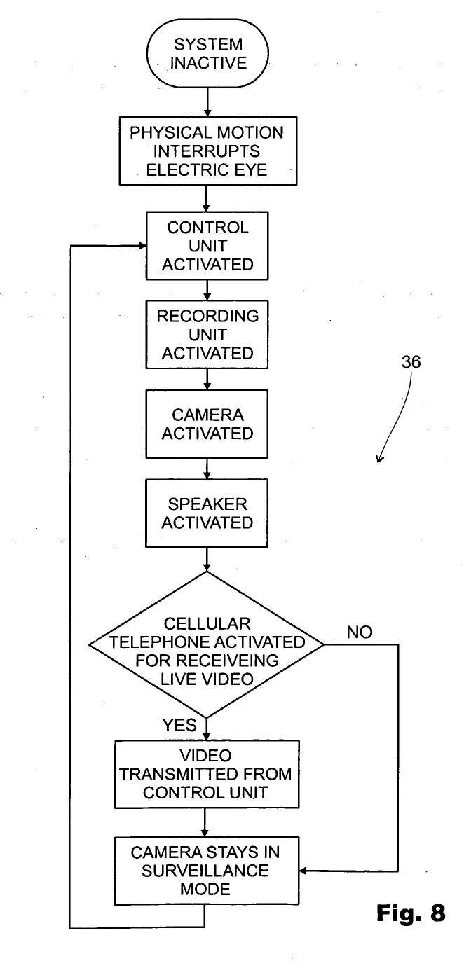

FIG. 8 is a schematic flowchart 36 of the sequence of operations that occur for the video monitoring system 10 when the electric eye 28 and the speaker 32 are incorporated into the system 10. As shown in FIG. 8, the individual, such as a parent or business owner, can access and view live images and video any time during the active surveillance mode of the monitoring system 10. However, the video monitoring system 10 simply stays in surveillance mode if not accessed by the individual's cellular telephone 22.

While certain novel features of the invention have been shown and described, it is not intended to be limited to the details above, and it is to be understood that numerous modifications, variations, and alterations may be made by those skilled in the art, without departing from the spirit of the invention or the scope of the appended claims.

What is claimed is:

1. A video monitoring system for monitoring activities occurring in a designated room, site, or area and transmitting live images and video of the monitored activities to an off site location, comprising:
a surveillance camera;
a platform on which the surveillance camera is pivotally mounted;
a control unit electrically interconnected to the surveillance camera;
a recording device electrically coupled to the surveillance camera and the control unit for recording the activities occurring in the room simultaneous with the operation of the surveillance camera;
a cellular telephone for receiving the live images and video transmitted from the control unit; and
the control unit capable of continuously transmitting live images and video to the cellular telephone so that the activities occurring in the room, site, or area can be continuously monitored and viewed by an individual in possession of the cellular telephone and that is located remote from the room, site or area being monitored.

2. The video monitoring system of claim 1 further comprising an electric eye electrically coupled to the surveillance camera and the control unit and actuated by ambient physical motion interrupting an electrical beam produced by the electric eye.

3. The video monitoring system of claim 2 further comprising a speaker electrically interconnected to the electric eye, the control unit and the recording device and actuated concomitant with the actuation of the electric eye to audibly emit instructions, guidance and reminders.

4. A video monitoring system for monitoring individuals and activities occurring in a designated room, site or area and transmitting live images and video of the individuals and activities to a location that is off site, comprising:
a surveillance camera mounted in the room for monitoring the individuals and activities therein;
a platform for pivotally mounting the surveillance camera thereon;
a control unit electrically connected to the surveillance camera;
a recording device electrically coupled to the control unit and the surveillance camera for recording the activities occurring in the room simultaneous with the operation of the surveillance camera;
a cellular telephone capable of receiving the live images and video transmitted from the control unit;
an electric eye electrically coupled to the surveillance camera and the control unit and actuated by physical motion interrupting an electrical beam produced by the electric eye;
a speaker electrically interconnected to the electric eye, the control unit and the recording device and actuated concomitant with the actuation of the electric eye for audibly emitting pre-recorded instructions, guidance and reminders; and
the control unit capable of continuously transmitting the live images and video to the cellular telephone so that the activities occurring in the room can be continuously monitored and viewed by anyone in possession of the cellular telephone and that are remote from the room, site or area being monitored.
